(19) United States
(12) Patent Application Publication
(10) Pub. No.: US 2012/0245058 A1
(43) Pub. Date: Sep. 27, 2012

(54) Graphene-Containing Fluids for Oil and Gas Exploration and Production

(75) Inventors: Othon Monteiro, Houston, TX (US); Lirio Quintero, Houston, TX (US)

(73) Assignee: BAKER HUGHES INCORPORATED, Houston, TX (US)

(21) Appl. No.: 13/424,549

(22) Filed: Mar. 20, 2012

Related U.S. Application Data
(60) Provisional application No. 61/466,259, filed on Mar. 22, 2011.

(51) Int. Cl. C09K 8/03; C09K 8/36

(52) U.S. Cl. 507/110; 507/128; 507/129; 507/131; 507/135; 507/136; 507/140; 507/209; 507/238; 507/239; 507/244; 507/252; 507/261; 507/269; 977/773; 977/902

(57) ABSTRACT

A base fluid may contain graphene nanoparticles where the base fluid may include an oil-based fluid, a water-based fluid, and combinations thereof. The oil-based fluid may be a brine-in-oil emulsion, or a water-in-oil emulsion, and the water-based fluid may be an oil-in-water emulsion, or an oil-in-brine emulsion; and combinations thereof. The addition of graphene nanoparticles to the base fluid may improve one or more properties of the fluid, which may include the flow assurance properties of the fluid, the fluid loss control properties of the fluid, the rheological properties of the fluid, the stability of the fluid, the lubricity of the fluid, the electrical properties of the fluid, the viscosity of the fluid, the thermal properties of the fluid, and combinations thereof. The fluid may be a drilling fluid, a completion fluid, a production fluid, and/or a servicing fluid.

### CROSS REFERENCE TO RELATED APPLICATION

This application claims the benefit of U.S. Provisional Application Ser. No. 61/466,259 filed Mar. 22, 2011, incorporated by reference herein in its entirety.

### TECHNICAL FIELD

The present invention relates to a fluid composition that may have graphene nanoparticles and a base fluid selected from the group consisting of a water-based fluid, an oil-based fluid, and combinations thereof; and methods of using the fluid composition.

### BACKGROUND

Fluids used in the drilling, completion, production, and remediation of subterranean oil and gas wells are known. It will be appreciated that within the context herein, the term “fluid” also encompasses “drilling fluids”, “completion fluids”, “workover fluids”, “servicing fluids”, “production fluids”, and “remediation fluids”.

It is apparent to those selecting or using a fluid for oil and/or gas exploration, and field development that an essential component of a selected fluid is that it be properly balanced to achieve the necessary characteristics for the specific end application. Because fluids are called upon to perform a number of tasks simultaneously, this desirable balance is not always easy to achieve. It is also important for the properties of the fluid to be stable, for instance that the rheological properties (viscosity, etc.) are stable throughout the pressure and temperature ranges that the fluid experiences, possibly including high temperature, high pressure conditions, which are abbreviated HTHP.

Drilling fluids are typically classified according to their base fluid. In water-based fluids, solid particles are suspended in a continuous phase consisting of water or brine. Oil can be emulsified in the water which is the continuous phase. “Water-based fluid” is used herein to include fluids having an aqueous continuous phase where the aqueous continuous phase can be all water or brine, an oil-in-water emulsion, or an oil-in-brine emulsion. Brine-based fluids, of course are water-based fluid, in which the aqueous component is brine.

Oil-based fluids are the opposite or inverse of water-based fluids. “Oil-based fluid” is used herein to include fluids having a non-aqueous continuous phase where the non-aqueous continuous phase is all oil, a water-in-oil emulsion, or a brine-in-oil emulsion. In oil-based fluids, solid particles are suspended in a continuous phase consisting of oil. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally-occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

Formation damage involves undesirable alteration of the initial characteristics of a producing formation, typically by exposure to drilling fluids, completion fluids, or in the production phase of the well. If the fluid formulations used in drilling, completion, production, or remediation operations are not engineered according to the need for the specific application, the effective permeability and pore volume of the producible formation in the near-wellbore region tend to decrease.

There are many mechanism of formation damage known to those skilled in the art; however, a few examples are listed here. First, solid particles from the fluid may physically plug or bridge across flowpaths in the porous formation. Second, when water contacts certain clay minerals in the formation, the clays typically swell, thus increasing in volume and in turn decreasing the pore volume. Third, chemical reactions within the fluid may precipitate solids or semisolids that plug pore spaces. Another possible mechanism of formation damage includes phase transitions due to changes in pressure or temperature of fluid composition during the wellbore construction and production may lead to precipitation or formation of asphaltenes, wax, scales, etc. Changes of wettability of the porous media may produce formation damage.

Reduced hydrocarbon production can result from reservoir damage when a drilling and completion fluid deeply invades the subterranean reservoir. It will also be understood that the drilling fluid, e.g. oil-based fluid, is deposited and concentrated at the borehole face and partially inside the formation. Many operators are interested in improving formation clean up and removing the cake or plugging material and/or removing formation damage after drilling into reservoirs with oil-based fluids.

It is also important when drilling subterranean formations to keep the wellbore stable, so that the walls of the borehole do not cave into the hole, and that the stability of the walls is maintained. Other issues involve improving the electrical resistivity or otherwise modifying the electrical conductivity of the fluid. In some cases, it is desirable to diminish the fluid resistivity, that is, improve the inverse property or the electrical conductivity of the fluid.

It would be desirable if fluid compositions and methods could be devised to avoid damage to the near-wellbore area of the formation, as well as assess location and extent of damage and aid and improve the ability to clean up damage and difficulties caused to the wellbore, the formation, equipment in the wellbore (for instance, stuck pipe), and to remove and/or resolve problems more completely and easily, without causing additional damage to the formation, wellbore and/or equipment.

There are a variety of functions and characteristics that are expected of completion fluids. The completion fluid may be placed in a well to facilitate final operations prior to initiation of production. Such final operations include, but are not necessarily limited to, setting screens, production lines, packers and/or downhole valves, and shooting perforations into the producing zones. The completion fluid assists with controlling a well if downhole hardware should fail, and the completion fluid does this without damaging the producing formation or completion components. Completion operation may include perforating the casing, setting the tubing and pumps in petroleum recovery operations. Both workover and completion fluids are used in part to control well pressure, to prevent the well from blowing out during completion or workover, or to prevent the collapse of well casing due to excessive pressure build-up.

Completion fluids are typically brines, such as chlorides, bromides, formates, but may be any non-damaging fluid having proper density and flow characteristics. Suitable salts for forming the brines include, but are not necessarily limited to, sodium chloride, calcium chloride, zinc chloride, potassium chloride, potassium bromide, sodium bromide, calcium bromide, zinc bromide, sodium formate, potassium formate, ammonium formate, cesium formate, and mixtures thereof. Chemical compatibility of the completion fluid with the reservoir formation and other fluids used in the well is key to avoid formation damage. Chemical additives, such as polymers and surface active materials are known in the art for being introduced to the brines used in well servicing fluids for various reasons that include, but are not limited to, increasing viscosity, and increasing the density of the brine. Water-thickening polymers serve to increase the viscosity of the brines and thus lift drilled solids from the well-bore. The completion fluid is usually filtered to a high degree to reduce the amount of solids that would otherwise be introduced to the near-wellbore area. A regular drilling fluid is usually not compatible for completion operations because of its solid content, pH, and ionic composition.

Completion fluids also help place certain completion-related equipment, such as gravel packs, without damaging the producing subterranean formation zones. Conventional drilling fluids are rarely suitable for completion operations due to their solids content, pH, and ionic composition. The completion fluid should be chemically compatible with the subterranean reservoir formation and its fluids.

Production fluids also have a multitude of functions and characteristics necessary for carrying out the production of the well. As used herein, the terms produced fluids and production fluids refer to liquids and/or gases removed from a subsurface formation, including, for example, an organic-rich rock formation. Said differently, a production fluid is any fluid that comes out of a well, i.e. produced from the well. Produced fluids may include both hydrocarbon fluids and non-hydrocarbon fluids. Production fluids may include, but are not limited to, pyrolyzed shale oil, synthesis gas, a pyrolysis product of coal, carbon dioxide, hydrogen sulfide, and water (including steam). Produced oil quality, overall production rate, and/or ultimate recoveries may be altered by altering the production fluid. Generally, all precautionary means may be taken to assure that the production flow from the well is uninterrupted or said differently, to maintain the flow assurance of the well, such as preventing asphaltenes deposition, wax deposition, and/or hydrates from forming within the production fluids.

The resulting hydrocarbon stream from a producing well is a mixture that must be separated into its gross components, such as oil, gas, and water. The phases of the hydrocarbon stream must also be separated; i.e. the liquids from the vapors. Two-phase separators separate phases only, such as the vapor from the liquid. Three-phase separators are necessary when the production fluid also contains water that must be removed. Separators are classified by shape, such as vertical separators and horizontal separators. When the gas-oil ratio is very low, a vertical separator is preferred. Horizontal separators should be used when the volume of the gas or liquid is very large. Once the hydrocarbon stream goes through the separator, the resultant production streams are processed according to whether it is a gas stream or an oil stream.

The processing of gas removes hydrogen sulfide (H₂S), water (H₂O), and carbon dioxide (CO₂). Amine treaters can be used to reduce the CO₂, and H₂S. The water may be removed from the gas by using a glycol treater or a dessicant. The processing of crude oil involves removing contaminants, such as sand, salt, H₂O, sediments, and other contaminants. However, H₂O is the largest contaminant in oil or gas. Several units may be employed to remove such contaminants from the oil stream. A heater-treater may be used to break up the oil-H₂O emulsion. A free-water knockout vessel separates free water from the oil stream produced from the well. An electrostatic heater treater employs an electric field to separate the water from the oil stream by attracting the electric charge of the water molecules. Demulsifying agents may be used to break emulsions by use of chemicals.

Servicing fluids, such as remediation fluids, workover fluids, and the like, have several functions and characteristics necessary for repairing a damaged well. Such fluids may be used for breaking emulsions already formed. The terms “remedial operations” and “remediate” are defined herein to include a lowering of the viscosity of gel damage and/or the partial or complete removal of damage of any type from a subterranean formation. Similarly, the term “remediation fluid” is defined herein to include any fluid that may be useful in remedial operations.

Before performing remedial operations, the production of the well must be stopped, as well as the pressure of the reservoir contained. To do this, any tubing-casing packers may be unseated, and then servicing fluids are run down the tubing-casing annulus and up the tubing string. These servicing fluids aid in balancing the pressure of the reservoir and prevent the influx of any reservoir fluids. The tubing may be removed from the well once the well pressure is under control. Tools typically used for remedial operations include wireline tools, packers, perforating guns, flow-rate sensors, electric logging sondes, etc.

It would be desirable if fluid compositions and methods could be tailored to the specific performance needs of drilling fluids, completion fluids, servicing fluids, and production fluids and thereby enhance the flow assurance properties of the fluid, the fluid loss control properties of the fluid, rheological properties of the fluid, the stability of the fluid, the lubricity of the fluid, the electrical properties of the fluid, the viscosity of the fluid, the thermal properties of the fluid, and combinations thereof. By doing this, damage to the near-wellbore area of the formation may be substantially avoided. In addition, it would be easier to assess location, extent of damage, and aid and improve the ability to clean up damage and difficulties caused to the wellbore, the formation, equipment in the wellbore (for instance, stuck pipe), and to remove and/or resolve problems more completely and easily, without causing additional damage to the formation, wellbore and/or equipment.

### SUMMARY

There is provided, in one non-limiting form, a fluid that may include a base fluid selected from the group consisting of an oil-based fluid, a water-based fluid, and combinations thereof. The fluid may also include graphene nanoparticles having at least one dimension less than 50 nm. Suitable graphene nanoparticles may include, but are not necessarily limited to, graphene, functionalized graphene, chemically-modified graphene, covalently-modified graphene, graphene oxide, and combinations thereof.

There is provided in another form, a method for improving one or more properties of a fluid. The property may be selected from the class consisting of the flow assurance properties of the fluid, the fluid loss control properties of the fluid, rheological properties of the fluid, the stability of the fluid, the lubricity of the fluid, the electrical properties of the fluid, the viscosity of the fluid, the thermal properties of the fluid, and combinations thereof. The method comprises adding graphene nanoparticles to a base fluid where the base fluid may be an oil-based fluid, a water-based fluid, and combinations thereof.

### BRIEF DESCRIPTION OF THE DRAWINGS

FIG. 1 is a graph illustrating the plastic viscosity of three drilling fluids having a brine-based internal phase and an oil-based external phase where the external phase is different for each drilling fluid; and

FIG. 2 is a graph illustrating the yield point of three drilling fluids having a brine-based internal phase and an oil-based external phase where the external phase is different for each drilling fluid; and

FIG. 3 is a graph illustrating the emulsion stability of two complex emulsions having different ratios of oil to water where graphene was added to the oil phase.

### DETAILED DESCRIPTION

It has been discovered that graphene nanoparticles may improve certain properties of a base fluid when added to the base fluid in an effective amount. Such properties that may be enhanced include the flow assurance properties of the fluid, the fluid loss control properties of the fluid, the electrical and thermal conductivity, emulsion stabilizers, wellbore strengthening components, drag reducers, wettability changers, as corrosion coatings, etc. The nanofluids for these types of applications may be designed by adding nano-composites and/or organic and inorganic nano-particulate materials, such as graphene nanoparticles.

Graphene is an allotrope of carbon, whose structure is a planar sheet of sp²-bonded graphite atoms that are densely packed in a 2-dimensional honeycomb crystal lattice. The term “graphene” is used herein to include particles that may contain more than one atomic plane, but still with a layered morphology, i.e. one in which one of the dimensions is significantly smaller than the other two. The typical maximum number of monoatomic-thick layers in the graphene nanoparticles here is about fifty (50). The structure of graphene is hexagonal, and it is often referred as a 2-dimensional (2-D) material. The 2-D structure of the graphene nanoparticles is of utmost importance when carrying out the useful applications relevant to the graphene nanoparticles. The applications of graphite, the 3-D version of graphene, are not equivalent to the 2-D applications of graphene.

Fundamental properties, such as electrical conductivity, Young modulus, thermal conductivity, dielectric properties, and those previously mentioned of graphene have been measured and compare well with those of carbon nanotubes. The 2-D morphology, however, provides significant benefits when dispersed in complex fluids, such as multi-phasic fluids or emulsions. Unique to this application is the engineering of the graphene dispersion within the different phases of the fluid, e.g. oil and water to achieve the desired properties.

The use of surface active materials, such as surfactants in one non-limiting embodiment, together with the graphene nanoparticles may form self-assembly structures that may enhance the thermodynamic, physical, and rheological properties of these types of fluids. The use of surface active materials is optional. These graphene nanoparticles are dispersed in the base fluid. The base fluid may be a drilling fluid, a completion fluid, a production fluid, or a servicing fluid. The base fluid may be an oil-based fluid or a water-based fluid, or the base fluid may be a single-phase fluid, or a poly-phase fluid, such as an emulsion of oil-in-water (O/W); water-in-oil (W/O); or a multiple emulsion, such as but not limited to water-in-oil-in-water (W/O/W), or oil-in-water-in-oil (O/W/O). The graphene nanoparticles may be used in conventional operations and challenging operations that require stable fluids for high temperature and pressure conditions (HTHP).

In the present context, graphene nanoparticles may have at least one dimension less 50 nm, although other dimensions may be larger than this. In a non-limiting embodiment, the graphene nanoparticles may have one dimension less than 30 nm, or alternatively 10 nm. In one non-limiting instance, the smallest dimension of the graphene nanoparticles may be less than 5 nm, but the length of the graphene nanoparticles may be much longer than 100 nm, for instance 1000 nm or more. Such graphene nanoparticles would be within the scope of the fluids herein.

It should be understood that surface-modified graphene nanoparticles may find utility in the compositions and methods herein. “Surface-modification” is defined here as the process of altering or modifying the surface properties of a particle by any means, including but not limited to physical, chemical, electrochemical or mechanical means, and with the intent to provide a unique desirable property or combination of properties to the surface of the graphene nanoparticle, which differs from the properties of the surface of the unprocessed graphene nanoparticle.

Functionalized graphene nanoparticles are defined herein as those which have had their edges or surfaces modified to contain at least one functional group including, but not necessarily limited to, sulfonate, sulfate, sulfosuccinate, thiosulfate, succinate, carboxylate, hydroxyl, glucoside, ethoxylate, propoxylate, phosphate, ether, amines, amides, ethoxylate-propoxylate and combinations thereof.

These enormous surface areas per volume dramatically increase the interaction of the graphene nanoparticles with the matrix or surrounding fluid. This surface area may serve as sites for bonding with functional groups and can influence crystallization, chain entanglement, and morphology, and thus can generate a variety of properties in the matrix or fluid.

In the present context, the fluid may include the base fluid, such as but not limited to a drilling fluid, a completion fluid, a production fluid, or a servicing fluid. For instance, it is anticipated that graphene nanoparticles and conventional polymers or copolymers may be linked or bonded together directly or through certain intermediate chemical linkages to combine some of the advantageous properties of each. Additionally, because of the very large surface area to volume present with graphene nanoparticles, it is expected that in most, if not all cases, much less proportion of graphene nanoparticles need be employed relative to micron-sized additives conventionally used to achieve or accomplish a similar effect.

Similarly, polymers may be connected with the graphene nanoparticles in particular ways, such as by cross-linking-type connections, hydrogen bonding, covalent bonding and the like. Suitable polymers include, but are not necessarily limited to, poly(m-phenylenevinylene-co-2,5-dioctoxy-p-phenylenevinylene) (PmPV), polyaniline, poly(para-phenylenevinylene) (PPV), poly(methyl methacrylate) (PMMA), polyvinyl alcohol (PVA), polyethylene propoxylate copolymers) (EO-PO copolymers), and the like. Such graphene nanoparticle-polymer hybrids may use graphene nanoparticles as polymer-type building blocks in conventional copolymer-type structures, such as block copolymers, graft copolymers, and the like.

In one sense, such fluids have made use of nanoparticles for many years, since the clays commonly used in drilling fluids are naturally-occurring, 1 nm thick discs of aluminosilicates. Such nanoparticles exhibit extraordinary rheological properties in water and oil. However, in contrast, the nanoparticles that are the main topic herein are synthetically formed graphene nanoparticles where size, shape and chemical composition are carefully controlled.

The graphene nanoparticles may be functionally modified to introduce chemical functional groups thereon, for instance by reacting the graphene nanoparticles with a peroxide such as diacyl peroxide to add acyl groups which are in turn reacted with diamines to give amine functionality, which may be further reacted.

The fluids herein, may have a base fluid, such as but not limited to drilling fluids, completion fluids, production fluids, and servicing fluids. Graphene nanoparticles may be added to the base fluid to beneficially affect the properties of the fluid. In some cases, the graphene nanoparticles may change the properties of the fluids in which they reside, based on various stimuli including, but not necessarily limited to, temperature, pressure, pH, chemical composition, salinity, and the like. This is due to the fact that the graphene nanoparticles can be custom designed on an atomic level to have very specific functional groups, and thus the graphene nanoparticles react to a change in surroundings or conditions in a way that is beneficial. It should be understood that it is expected that graphene nanoparticles may have more than one type of functional group, making them multifunctional. Multifunctional graphene nanoparticles may be useful for simultaneous applications, in a non-limiting example of a fluid, lubricating the bit, stabilizing the shale while drilling and provide low shear rate viscosity. In another non-restrictive embodiment, graphene nanoparticles suitable for stabilizing shale include those having an electric charge that permits them to associate with the shale. In a non-limiting embodiment, graphene particles may be part of a blend where the blend also includes microcrystalline graphite, and nanocrystalline graphite, nanotubes, and combinations thereof.

Such fluids may have surface active materials; e.g. surfactants, polymers, and/or co-polymers; present and interacting with the graphene nanoparticles to help the fluids achieve these goals. Such fluids are expected to find uses in reservoir flooding, reservoir operations including reservoir imaging, drilling fluids, completion fluids, and reservoir stimulation. It may be helpful in designing new fluids containing engineered graphene nanoparticles to match the amount of the graphene nanoparticles with the proper surface active material/base fluid ratio to achieve the desired dispersion for the particular fluid. Surface active materials are generally considered optional, but may be used to improve the quality of the dispersion of the graphene nanoparticles. Such surface active materials may be present in the base fluids in amounts from about 0.1 wt % independently to about 15 wt %, alternatively from about 0.05 wt % independently to about 5 wt %, where “independently” as used herein means that any lower threshold may be combined with any upper threshold to define an acceptable alternative range.

Ways of dispersing colloidal-size particles in fluids is known, but how to disperse graphene nanoparticles within the fluids may be a challenge. Expected suitable surface active materials may include, but are not necessarily limited to non-ionic, anionic, cationic, amphoteric surfactants, and blends thereof. Suitable nonionic surface active materials may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surface active materials may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surface active materials may include, but are not necessarily limited to, arginine methyl esters, alkanolamines and alkylenediamides. Suitable surface active materials may also include surfactants containing a non-ionic spacer-arm central extension and an ionic or nonionic polar group. Other suitable surface active materials may be dimeric or gemini surfactants, cleavable surfactants, janus surfactants and extended surfactants, also called extended chain surfactants.

It is also anticipated that combinations of certain surface active materials and graphene nanoparticles will “self-assemble” into useful structures, similar to the way certain compositions containing surface active materials self-assemble into liquid crystals of various different structures and orientations.

Such graphene nanoparticles may include graphene, functionalized graphene, chemically-modified graphene, covalently-modified graphene, graphene oxide, and combinations thereof. The functionalized graphene nanoparticles may be functionally modified by, but are not necessarily limited to, sulfonate, sulfate, sulfosuccinate, thiosulfate, succinate, carboxylate, hydroxyl, glucoside, ethoxylate, propoxylate, phosphate, ether, amines, amides, and combinations thereof. The chemically-modified graphene nanoparticles may have been chemically reacted to bear functional groups including, but not necessarily limited to, SH, NH₂, NHCO, OH, COOH, F, Br, Cl, I, H, R—NH, R—O, R—S, CO, COCl and SOCl, where R is selected from the group consisting of low molecular weight organic chains with a carbon number on average but not necessarily limited to 10 or less.

Covalent functionalization may include, but is not necessarily limited to, oxidation and subsequent chemical modification of oxidized nanoparticles, fluorination, free radical additions, addition of carbenes, nitrenes and other radicals, arylamine attachment via diazonium chemistry, and the like. Besides covalent functionalization, chemical functionality may be introduced by noncovalent functionalization, π-π interactions and polymer interactions, such as wrapping a graphene nanoparticle with a polymer, direct attachment of reactants to graphene nanoparticles by attacking the sp² bonds, direct attachment to ends of graphene nanoparticles or to the edges of the graphene nanoparticles, and the like. The amount of graphene nanoparticles in the fluid may range from about 0.0001 wt % independently to about 15 wt %, and from about 0.001 wt % independently to about wt % in an alternate non-limiting embodiment.

Fluids containing graphene nanoparticles are also expected to have improved electrical conductivity. In one non-restrictive version, the average nanoparticle length for the nanoparticles to achieve this effect ranges from about 1 nm independently to about 10,000 nm, alternatively from about 10 nm independently to about 1000 nm. Graphene nanoparticles can conduct electrical charge, so they may improve the conductivity of the fluids. Enhanced electrical conductivity of the fluids may form an electrically conductive filter cake that highly improves real time high resolution logging processes, as compared with an otherwise identical fluid absent the graphene nanoparticles.

The amount of graphene nanoparticles in a fluid to modify the electrical conductivity of the fluid may range from about 0.0001 wt % independently to about 15 wt %, alternatively from about 0.001 wt % independently to about 5 wt %. Surface active materials useful to include in fluids to improve the dispersion of the graphene within the fluid in order to improve the conductivity or resistivity thereof are expected to include, but not necessarily be limited to, non-ionic, anionic, cationic, amphoteric and zwitterionic surface active materials, janus surface active materials, and blends thereof as previously mentioned, and surface active materials may be expected to be present in amounts of from about 0.05 wt % to about 15 wt % within the fluid.

Fluids containing graphene nanoparticles are also expected to have enhanced fluid loss control properties when compared to fluids lacking the graphene nanoparticles. Fluid loss control is generally associated with the procedures using drilling fluids and completion fluids. Adding graphene nanoparticles to a drilling fluid or completion fluid may minimize the loss of such a fluid into the formation or reservoir. The amount of graphene nanoparticles in a fluid to modify the fluid loss control properties of the fluid may range from about 0.0001 wt % to about 15 wt %, alternatively from about 0.001 wt % to about 5 wt %.

Fluids containing graphene nanoparticles are also expected to have improved lubricity when compared to fluids lacking the graphene nanoparticles. The amount of graphene nanoparticles in a fluid to modify the lubricity of the fluid may range from about 0.0001 wt % to about 15 wt %, alternatively from about 0.001 wt % to about 5 wt %.

Graphene nanoparticles are also expected to improve the thermal properties of a fluid by stabilizing fluids over a wide range of temperature and/or pressure conditions, including the HTHP environments of very deep wells, and at proportions much less than current stability additives. By stabilizing the fluids is meant keeping the rheology of the fluid the same, such as the viscosity of the fluid, over these ranges. Graphene nanoparticles may act as an emulsion stabilizer if they are adsorbed to a fluid-fluid interface, and promote emulsion stabilization. The type of emulsion obtained would depend on the wettability of the graphene nanoparticles at the oil/water interface. The stabilization mechanism works via a viscoelastic interfacial film formed by the graphene nanoparticles residing at the oil/water interface, reducing drainage and rupture of the film between droplets. The degree of stabilization would depend on the particle detachment energy which is related to the free energies involved in removing an adsorbed graphene nanoparticle from the interface. In one non-limiting embodiment, the stabilization of the emulsion forming the fluid may involve surfactant-induced graphene nanoparticle flocculation and synergy between the surfactant and the graphene nanoparticles, as similarly described by Binks et al “Synergistic Interaction in Emulsions Stabilized by a Mixture of Silica Nanoparticles and Cationic Surfactant”, Langmuir 2007, 23, 3626-3636 and Binks and Rodrigues, “Enhanced Stabilization of Emulsions Due to Surfactant-Induced Nanoparticle Flocculation”, Langmuir 2007, 23, 7436-7439, both incorporated herein by reference in their entirety.

In one non-limiting embodiment, the fluid would be stable at temperatures up to 300° C. Suitable graphene nanoparticles for this application include, but are not necessarily limited to, those which can carry a charge, as well as those with functional groups including, but not necessarily limited to, hydrophilic groups and/or hydrophobic groups, etc. It is expected that the proportions of such graphene nanoparticles useful to impart stability may range from about 0.0001 wt % independently to about 15 wt %; alternatively from about 0.001 wt % independently to about 5 wt %. These fluids would be more stable than otherwise identical fluids absent the graphene nanoparticles. Particular graphene nanoparticles useful for stabilizing emulsions include, but are not necessarily limited to, graphene nanoparticles, functionalized graphene nanoparticles, chemically-modified graphene, covalently-modified graphene, graphene oxide, and combinations thereof.

As described, many fluids are emulsions, such as O/W or W/O emulsions. It is important that these emulsion fluids maintain their emulsion properties during their use. Surface active materials or combinations of surface active materials with co-surfactants are often used in conventional emulsion drilling fluids to stabilize them. However, it is expected that graphene nanoparticles could also provide this emulsion stabilizing effect in a much lower proportion. It is expected that the proportions of such graphene nanoparticles useful to impart emulsion stability may range from about 0.0001 wt % independently to about 15 wt %; alternatively from about 0.001 wt % independently to about 5 wt %. Graphene nanoparticles suitable to reverse the wettability of solids and downhole materials may include, but are not necessarily limited to, those having at least one dimension less than 50 nm. In a non-limiting embodiment, the graphene nanoparticles may have one dimension less than 30 nm, or alternatively 10 nm. The graphene nanoparticles may be surface modified graphene nanoparticles; which may be optionally functionalized with functional groups including, but not necessarily limited to, sulfonate, sulfate, sulfosuccinate, thiosulfate, succinate, carboxylate, hydroxyl, glucoside, ethoxylate, propoxylate, phosphate, ether, amines, amides, an ethoxylate-propoxylate, and combinations thereof.

Drilling and completion fluids are also expected to benefit from the presence of graphene nanoparticles within them. Completion fluids generally do not contain solids; however, because of the extremely small size of the graphene nanoparticles, their presence may be tolerated in low proportions while still imparting improvement to the fluid. For instance, improvements in fluid loss and viscosity of clear brines may help seal off porous media in the face of the wellbore without the formation of a thick filter cake (few mm or higher) in the usual way that “filter cake” is understood. For instance, it is expected that an internal structure in the near wellbore region (not a “cake” on the wellbore surface), formed from drilling solids and nanoparticles, without otherwise added solids, may usefully serve to control fluid invasion in the rock formation.

Because of the small size of the graphene nanoparticles, they may pass through the pores of the near wellbore region to form an internal structure that may control fluid invasion. The electrical or other forces that hold them together would create a structure that controls fluid invasion. Similarly, once those forces are disrupted and the fluid invasion control is no longer needed, the graphene nanoparticles may be readily produced back from the near wellbore region. This is particularly beneficial in open hole wells completed with a screen; the small particles will not block the screen, which is one of the common causes of damage. The reduced solid volumes with increased surface area would thus help maintain equivalent viscosities of such completion fluids, workover fluids, and servicing fluids. It is expected that the proportions of such nanoparticles useful to provide beneficial properties to fluids may range from about 0.0001 wt % independently to about 15 wt %; alternatively from about 0.001 wt % independently to about 5 wt %.

The potential to form a thin, non-erodible and largely impermeable structure similar in function to a filter cake with well-dispersed and tightly packed “fabric” and structural graphene nanoparticles, graphene nanoparticle-based fluids may be expected to eliminate or reduce the scope of reservoir damage, while improving well productivity. Because of the large surface area to volume ratio of graphene nanoparticles in these structures, cleaning compositions and methods used before completing a well may remove these structures easily from the borehole wall by permitting intensive interactions with the fluid. Properly designed and engineered graphene nanoparticles are expected to provide effective sealing of the porous and permeable zones, and naturally fractured formations. Because of the relatively smaller sizes of the graphene nanoparticles, the potential for near-wellbore damage of the formation is greatly reduced as compared with the situation where a conventional filter cake, having relatively larger particles, is removed.

Shallow water flow problems associated with deep water drilling may also be addressed using graphene nanoparticles. Due to their small size, these graphene nanoparticles may easily pass through the pores and inter-granular boundaries of the shallow water flow sand zone and the porous and permeable matrix of the shallow water flow sand. Thus, engineered graphene nanoparticles with gluing, sealing, filling and cementation properties are expected to increase the inter-granular bond strength, reduce porosity and permeability of the near wellbore formations in the shallow water flow zone. Such engineering of graphene nanoparticles would be expected to reduce the matrix flow potential of the shallow water flow zone due to effective sealing of the near-wellbore zone. Due to the inter-particle bonding and matrix strengthening effect of the graphene nanoparticle fluid to the near-wellbore shallow water flow zone, it is also expected to improve the borehole and sea bed equipment stability used in offshore drilling and production.

These properties of graphene nanoparticles may also be understood to consolidate unconsolidated formations to form bonded networks of particles within the formation to create an integrated ring of rock mass around the borehole wall. Such a nanoparticle-enhanced rock cylinder in the near wellbore region may tolerate much higher in-situ stresses to avoid collapse as well as undesirable fracturing of the formation.

Production fluids are also expected to benefit from the presence of graphene nanoparticles within them. Introducing graphene nanoparticles into a production fluid once the production fluid has been produced, but before it is processed would improve many properties of the production fluid. The graphene nanoparticles may also be introduced while the production fluid is being processed. More specifically, the flow assurance of the production fluid may be enhanced when compared to fluids lacking the graphene nanoparticles. The flow assurance of a production fluid relates to assuring that the flow of the produced fluid flows out of the formation or reservoir in an uninterrupted manner, such as from the reservoir into the wellbore, into a pipe going to a tank, etc. The amount of graphene nanoparticles in a fluid to modify the flow assurance properties of the fluid may range from about 0.0001 wt % to about 15 wt %, alternatively from about 0.001 wt % to about 5 wt %.

The invention will be further described with respect to the following Examples which are not meant to limit the invention, but rather to further illustrate the various embodiments.

### Example 1

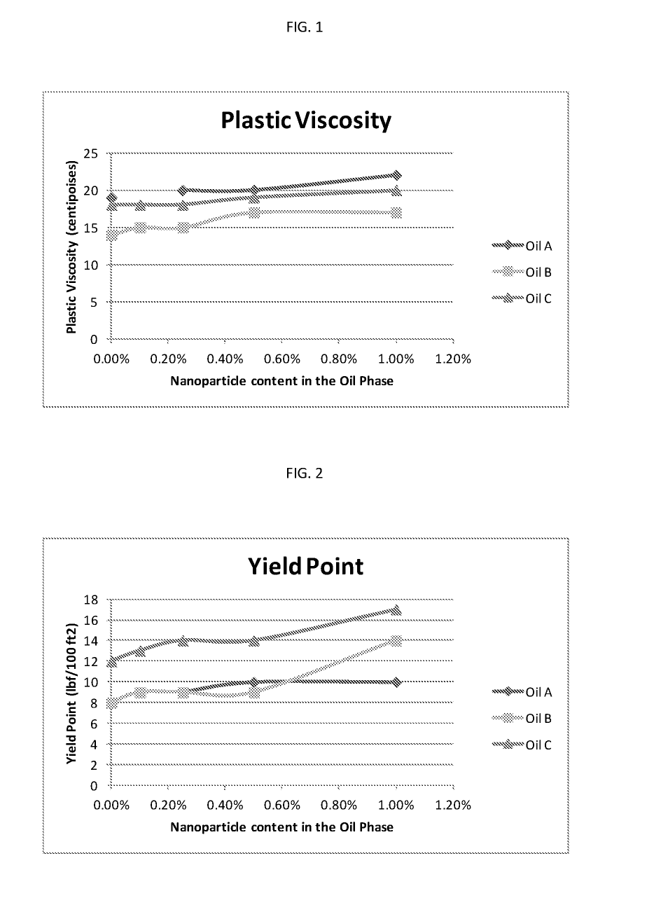

The graph of FIG. 1 illustrates the plastic viscosity of three drilling fluids having a brine-based internal phase and an oil-based external phase where the external phase is different for each drilling fluid. Each drilling fluid had the same specific gravity and external phase to internal phase ratio. However, each drilling fluid had a different external phase where Oil A had an external phase of a first mineral oil (Clairsol-NS), Oil B had an external phase of a second mineral oil (Escaid 110), and Oil C had an external phase of a third mineral oil (GT 3000). As noted by the graph, the plastic viscosity of each drilling fluid increased as the amount of graphene within the external phase also increased.

### Example 2

FIG. 2 illustrates the yield point of three drilling fluids having a brine-based internal phase and an oil-based external phase where the external phase is different for each drilling fluid. Each drilling fluid had the same specific gravity and external phase to internal phase ratio. However, each drilling fluid had a different external fluid where Oil A had an external phase of a first mineral oil (Clairsol-NS), Oil B had an external phase of a second mineral oil (Escaid 110), and Oil C had an external phase of a third mineral oil (GT 3000). As noted by the graph, the yield point of all three drilling fluids increased as the amount of graphene within the external phase also increased.

### Example 3

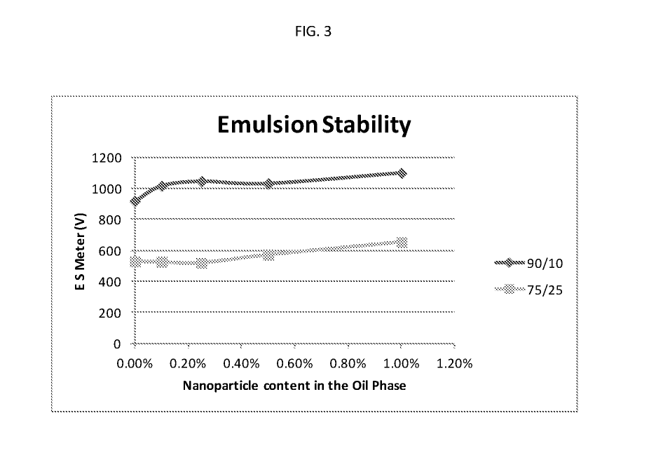

FIG. 3 is a graph illustrating the emulsion stability of two complex emulsions having different ratios of oil to water. Each complex emulsion had graphene added to the oil phase of the complex emulsion. Each complex emulsion had an external phase, an internal phase, emulsifiers, viscosifiers, and weighting solids. The internal phase of each complex emulsions was 20*CaCl₂ brine, and the external phase was a mineral oil. The 90/10 fluid was a complex emulsion having an oil/water (O/W) ratio of 90/10. The 75/25 fluid was a complex emulsion having an oil/water (O/W) ratio of 75/25. Emulsion stability was measured with an Electrical Stability Meter where a higher reading indicates a more stable emulsion. As noted by the graph, emulsion stability of both drilling fluid increased with an increasing amount of graphene added into the oil phase of each complex emulsion.

In the foregoing specification, the invention has been described with reference to specific embodiments thereof, and has been suggested as effective in providing effective methods and compositions for improving completion fluids, production fluids, and servicing fluids used in drilling, completing, producing, and remediating subterranean reservoirs and formations. However, it will be evident that various modifications and changes may be made thereto without departing from the broader spirit or scope of the invention as set forth in the appended claims. Accordingly, the specification is to be regarded in an illustrative rather than a restrictive sense. For example, specific combinations of components and/or reaction conditions for forming the graphene nanoparticles, whether modified to have particular shapes or certain functional groups thereon, but not specifically identified or tried in a particular completion fluid, production fluid, or servicing fluid to improve the properties therein, are anticipated to be within the scope of this invention.

The present invention may suitably comprise, consist or consist essentially of the elements disclosed and may be practiced in the absence of an element not disclosed. For instance, the fluid may consist of or consist essentially of the base fluid and the graphene nanoparticles, as further defined in the claims. Alternatively, the fluid may consist of or consist essentially of the base fluid, the graphene nanoparticles, and one or more surface active materials, as further defined in the claims. In each of these examples, the fluid may contain conventional additives.

The words “comprising” and “comprises” as used throughout the claims is to be interpreted as meaning “including but not limited to”.

What is claimed is:

1. A fluid comprising:
a base fluid selected from the group consisting of an oil-based fluid, a water-based fluid, and combinations thereof; and
graphene nanoparticles.

2. The fluid of claim 1 further comprising graphite, nanotubes, and combinations thereof.

3. The fluid of claim 1 where the base fluid is selected from the group consisting of a completion fluid, a production fluid, and a servicing fluid.

4. The fluid of claim 1 where the oil-based fluid is selected from the group consisting of a brine-in-oil emulsion, or a water-in-oil emulsion; where the water-based fluid is selected from the class consisting of an oil-in-water emulsion, or an oil-in-brine emulsion; and combinations thereof.

5. The fluid of claim 1 where the graphene nanoparticles have at least one dimension less than 50 nm.

6. The fluid of claim 1 where the graphene nanoparticles are selected from the group consisting of graphene, functionalized graphene, chemically-modified graphene, covalently-modified graphene, graphene oxide, and combinations thereof.

7. The fluid of claim 1 where the graphene nanoparticles are present in the fluid in an amount effective to improve a property selected from the class consisting of the flow assurance properties of the fluid, the fluid loss control properties of the fluid, the rheological properties of the fluid, the stability of the fluid, the emulsion stabilization of the fluid, the lubricity of the fluid, the electrical properties of the fluid, the thermal properties of the fluid, and combinations thereof.

8. The fluid of claim 1 where the graphene nanoparticles are functionalized nanoparticles having at least one functional group selected from the group consisting of a sulfonate, a sulfate, a sulfosuccinate, a thiosulfate, a succinate, a glucoside, an ethoxylate, a propoxylate, a phosphate, an ether, and combinations thereof.

9. The fluid of claim 1 where the amount of graphene nanoparticles within the fluid range from about 0.0001 wt % to about 15 wt %.

10. The fluid of claim 1 further comprising a surface active material in an amount effective to suspend the graphene nanoparticles in the base fluid.

11. A fluid comprising:
a base fluid selected from the group consisting of a drilling fluid, a completion fluid, a production fluid, and a servicing fluid;
a graphene nanoparticle blend comprising graphene nanoparticles and another component selected from the group consisting of graphite, nanotubes, and combinations thereof, wherein the graphene nanoparticles are selected from the group consisting of graphene, functionalized graphene, chemically-modified graphene, covalently modified graphene, graphene oxide, and combinations thereof.

12. A method for improving a property of a fluid where the property is selected from the class consisting of the flow assurance properties of the fluid, the fluid loss control properties of the fluid, the rheological properties of the fluid, the stability of the fluid, the emulsion stabilization of the fluid, the lubricity of the fluid, the electrical properties of the fluid, the thermal properties of the fluid, and combinations thereof; wherein the method comprises adding graphene nanoparticles to a base fluid where the base fluid is selected from the group consisting of an oil-based fluid, a water-based fluid, and combinations thereof.

13. The method of claim 12 where the base fluid is selected from the group consisting of a drilling fluid, a completion fluid, a production fluid, and a servicing fluid.

14. The method of claim 12 where the oil-based fluid is selected from the group consisting of a brine-in-oil emulsion, or a water-in-oil emulsion; where the water-based fluid is selected from the class consisting of an oil-in-water emulsion, or an oil-in-brine emulsion; and combinations thereof.

15. The method of claim 12 where the graphene nanoparticles have at least one dimension less than 50 nm.

16. The method of claim 12 where the graphene nanoparticles are selected from the group consisting of graphene, functionalized graphene, covalently-modified graphene, chemically-modified graphene, graphene oxide, and combinations thereof.

17. The method of claim 12 where the graphene nanoparticles are functionalized nanoparticles having at least one functional group selected from the group consisting of a sulfonate, a sulfate, a sulfosuccinate, a thiosulfate, a succinate, a carboxylate, a hydroxyl, a glucoside, a ethoxylate, a propoxylate, a phosphate, an ether, an amine, an amide, and combinations thereof.

18. The method of claim 12 where the amount of graphene nanoparticles in the fluid range from about 0.0001 wt % to about 15 wt %.

19. The method of claim 12 further comprising a surface active material in an amount effective to suspend the graphene nanoparticles in the base fluid.

20. A method for improving a property of a fluid where the property is selected from the class consisting of the flow assurance properties of the fluid, the fluid loss control properties of the fluid, the rheological properties of the fluid, the stability of the fluid, the emulsion stabilization of the fluid, the lubricity of the fluid, the electrical properties of the fluid, the thermal properties of the fluid, and combinations thereof; where the method comprises:
adding a graphene nanoparticle blend to a base fluid comprising graphene nanoparticles and another component selected from the group consisting of graphite, nanotubes, and combinations thereof; wherein the base fluid is selected from the group consisting of a drilling fluid, a completion fluid, a production fluid, and a servicing fluid.
